(19) United States
(12) Patent Application Publication
(10) Pub. No.: US 2024/0396441 A1
(43) Pub. Date: Nov. 28, 2024

(54) POWERING DEVICE FOR IMAGE ACQUISITION, EQUIPMENT, METHOD, MEDIUM, AND PROGRAM PRODUCT

(71) Applicant: Beijing Zitiao Network Technology Co., Ltd., Beijing (CN)

(72) Inventors: Wenlong BAI, Beijing (CN); Jiu XIA, Beijing (CN)

(21) Appl. No.: 18/672,888

(22) Filed: May 23, 2024

(30) Foreign Application Priority Data
May 23, 2023 (CN) 202310593665.7

(51) Int. Cl. H02M 3/06; H02J 7/00; H02J 7/34; H04N 23/65

(52) U.S. Cl. CPC H02M 3/06; H02J 7/0063; H04N 23/65; H02J 7/345

(57) ABSTRACT

The present application provides a powering device, an equipment, a method, a medium, and a computer program product for image acquisition. The device includes: an energy storage circuit connected to a power supply and configured to store electric energy of the power supply; an image acquisition module connected to the energy storage circuit and configured to use the electric energy stored in the energy storage circuit for powering during image acquisition. In this way, when the image acquisition module needs a high current for image acquisition, the image acquisition module will not draw high current electric energy from the power supply, and the voltage of the power supply can be kept stable, thereby ensuring the stability of the operation of other circuit components that need to be powered by the power supply.

### CROSS-REFERENCE TO RELATED APPLICATION(S)

This application claims priority to Chinese Application No. 202310593665.7 filed May 23, 2023, the disclosure of which is incorporated herein by reference in its entity.

### FIELD

The present application relates to the field of circuit powering technology, and in particular to a powering device for image acquisition, equipment, method, medium and program product.

### BACKGROUND

Currently, when an image acquisition module (e.g., a camera) performs image acquisition, a high current will be drawn from a power supply upon requirement.

This may cause a voltage decrease of the power supply, resulting in a voltage decrease of an entire electrical system and affecting its operation.

### SUMMARY

In view of this, the purpose of the present application is to propose a powering device for image acquisition, equipment, method, medium and program product to solve or partially solve the above-mentioned technical problems.

Based on the above purpose, a first aspect of the present application provides a powering device for image acquisition. The powering device for image acquisition comprises: an energy storage circuit connected to a power supply and configured to store electric energy of the power supply; and an image acquisition module connected to the energy storage circuit and configured to use the electric energy stored in the energy storage circuit for powering during image acquisition.

Based on the same concept, a second aspect of the present application proposes an electronic equipment. The electronic equipment comprises: a power supply and the powering device for image acquisition according to the first aspect, which is connected to the power supply.

Based on the same concept, a third aspect of the present application proposes a powering method for image acquisition. The powering method for image acquisition comprises: storing electric energy of a power supply by using an energy storage circuit connected to the power supply; powering, in response to an image acquisition module performing image acquisition, the image acquisition module by using the electric energy stored in the energy storage circuit.

Based on the same concept, a fourth aspect of the present application proposes a non-transitory computer-readable storage medium, wherein the non-transitory computer-readable storage medium stores computer instructions for causing the computer to execute the method according to the third aspect.

Based on the same concept, a fifth aspect of the present application proposes a computer program product. The computer program product comprises computer program instructions that, when run on a computer, cause the computer to execute the method according to the third aspect.

From the above, it can be seen that the powering device for image acquisition, equipment, method, medium and program product provided by the present application stores the energy in the power supply in the energy storage circuit. In this way, when the image acquisition module needs a high current for image acquisition, the energy storage circuit is used to provide high current electric energy for image acquisition. And the power supply is not directly used for powering during image acquisition, so that the image acquisition module will not draw high current electric energy from the power supply, and the voltage of the power supply can be kept stable, thereby ensuring the stability of the operation of other circuit components that need to be powered by the power supply.

### BRIEF DESCRIPTION OF THE DRAWINGS

In order to more clearly illustrate the technical solutions in the present application or related technologies, the drawings required for use in descriptions of the embodiments or related technical are briefly introduced below. It is obvious that the drawings described below are merely for the embodiments of the present application. For the ordinary skilled in the art, other drawings can be obtained based on these drawings without any creative work.

FIG. 1A is a schematic structural diagram of a powering device for image acquisition according to an embodiment of the present application;

FIG. 1B is a schematic structural diagram of a powering device for image acquisition according to another embodiment of the present application;

FIG. 1C is a schematic structural diagram of a powering device for image acquisition according to yet another embodiment of the present application;

FIG. 1D is a circuit diagram of a boost circuit and an energy storage capacitor according to an embodiment of the present application;

FIG. 1E is a circuit diagram of a buck circuit according to an embodiment of the present application;

FIG. 2 is a schematic structural diagram of an electronic equipment according to an embodiment of the present application; and

FIG. 3 is a flow chart of a powering method for image acquisition according to an embodiment of the present application.

The description of reference numbers: 110 powering device for image acquisition; 111 energy storage circuit; 1111 energy storage capacitor; 1112 boost circuit, 11121 boost inductor, 11122 boost control chip, 11123 rectifier diode, 11124 boost feedback circuit; 1113 buck circuit, 11131 buck control chip, 11132 buck inductor, 11133 buck feedback circuit; 112 image acquisition module; 120 power supply; 100 electronic equipment.

### DETAILED DESCRIPTION OF EMBODIMENTS

It can be understood that the data (including but not limited to the data itself, an acquisition or use of the data) involved in the present technical solution should comply with the requirements of corresponding laws, regulations and relevant provisions.

The principles and spirit of the present application will be described below with reference to several exemplary embodiments. It should be understood that these embodiments are only provided to enable those skilled in the art to better understand and implement the present application, but are not intended to limit the scope of the present application in any way. Rather, these embodiments are provided to make the present application more thorough and complete, and to fully convey the scope of the present application to those skilled in the art.

In the application, it should be understood that the number of elements in the drawings is for illustration and not limitation, and the name is for distinction only and does not have any limiting meaning.

Based on the above description, the principles and spirit of the present application will be explained in detail below with reference to several representative embodiments of the present application.

Based on the situation described in the background, a time of flight (TOF) depth camera uses a Vertical-Cavity Surface-Emitting Laser (VCSEL) to emit infrared laser, which is projected onto an object in environment and reflected back. The distance between the object in the environment and the camera is calculated by detecting the time the laser passes through the distance. In order to meet the needs of wide activity range of extended reality devices (such as Virtual Reality (VR) device, Augmented Reality (AR) device, Mixed Reality (MR) device) and high depth accuracy requirements for MR/VR/AR applications, VCSEL requires high voltage and power, resulting in high peak current requirements for powering.

If a traditional DC-DC chip (a device that converts electric energy of one voltage value into electric energy of another voltage value) is used to directly power the TOF depth camera, when the VCSEL of the depth camera turns on for exposure, it will draw a huge peak current from the power supply of the entire system, which may cause a drop in the power supply voltage of the entire extended reality device system, affect the normal operation of other modules (electronic modules in the extended reality device except the TOF depth camera), and even cause the extended reality device to shut down due to overcurrent protection.

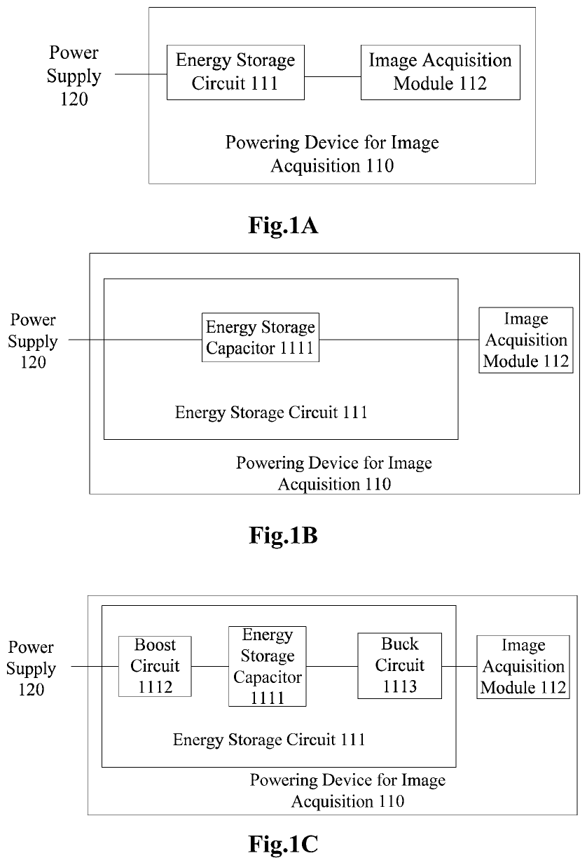

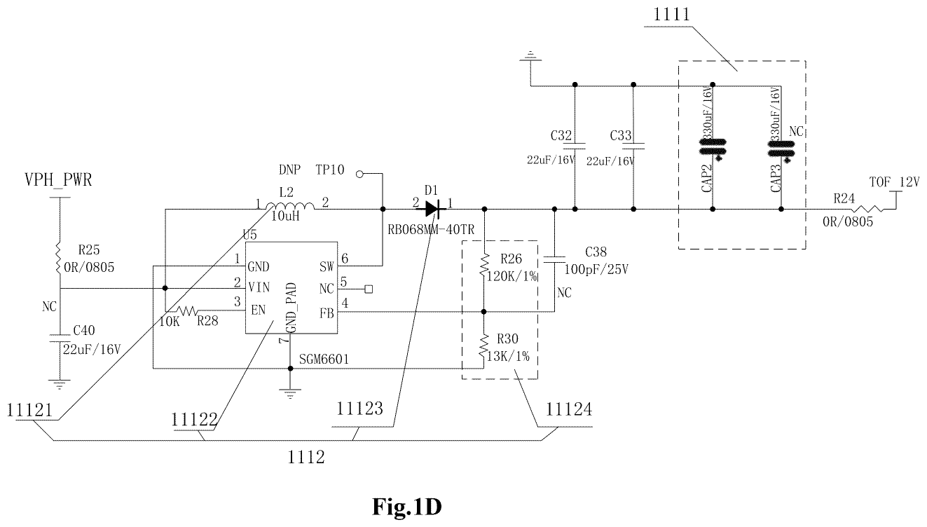

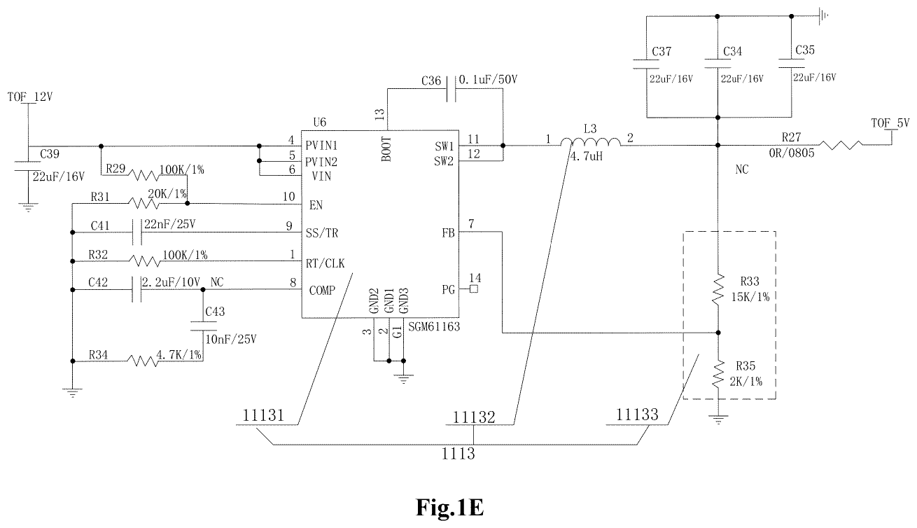

The following describes a powering device for image acquisition 110 proposed in the embodiment of the present application, as shown in FIG. 1A. The powering device for image acquisition 110 includes an energy storage circuit 111.

The energy storage circuit 111 is connected between a power supply 120 and an image acquisition module 112, and is configured to store electric energy of the power supply 120. When the image acquisition module 112 performs image acquisition, the electric energy stored in the energy storage circuit 111 is used to power the image acquisition module 112.

In an implementation, the energy in the power supply 120 can be stored in the energy storage circuit 111. The image acquisition module 112 needs a short-term high current, when performing image acquisition, in order to provide the exposure requirement for image acquisition. Therefore, when the image acquisition module 112 is performing image acquisition, the energy storage circuit 111 is used to provide electric energy of high current for image acquisition, without using the power supply 120 for direct powering. This ensures that the power supply 120 is not affected by the high current drawing of the image acquisition module 112, maintains the stability of the voltage of the power supply 120. At the same time, it is ensured that other circuit components powered by the power supply 120 can work stably and will not be shut down due to overcurrent protection caused by a voltage decrease of the power supply. The image acquisition module 112 includes: a camera, a video camera, or a TOF depth camera.

After supplying power to the image acquisition module 112, the energy storage circuit 111 will charge an energy storage capacitor 1111 again through the power supply 120, wait for the next image acquisition by the image acquisition module 112, and supply power to the image acquisition module 112 during the next image acquisition process.

Through the above scheme, the energy storage circuit 111 is used to supply power during image acquisition process, so that the image acquisition module 112 will not draw high current electric energy from the power supply 120, and the voltage of the power supply 120 can be kept stable, thereby ensuring the stability of the operation of other circuit components that need to be powered by the power supply 120.

In some embodiments, as shown in FIG. 1B, the energy storage circuit 111 includes an energy storage capacitor 1111.

The energy storage capacitor 1111 is configured to store the electric energy of the power supply 120 in the energy storage capacitor 1111.

In an implementation, the energy storage function of the energy storage capacitor 1111 is used to store the electric energy of the power supply 120 into the energy storage capacitor 1111, and the energy storage capacitor 1111 uses a relatively large capacitor, for example, a capacitor of 330 uF (or of another capacitance). If more energy storage capacitors 1111 are needed for energy storage, multiple energy storage capacitors 1111 can be connected in parallel (such as the energy storage capacitors CAP2 and CAP3 in FIG. 1D), wherein the number of corresponding energy storage capacitors 1111 can be selected according to actual needs, and is not specifically limited here.

In some embodiments, the energy storage circuit 111 also includes a first filter capacitor (C32 and C33 in FIG. 1D), which is arranged in parallel with the energy storage capacitor 1111.

In an implementation, in order to avoid the interference from alternating current (AC) pulsating currents, the first filter capacitor is arranged in parallel with the energy storage capacitor 1111. Due to the characteristics of passing through AC and blocking direct current (DC) for the first filter capacitor, some AC electricity can be filtered out, so that the electricity stored in the energy storage capacitor 1111 will not be affected by AC electricity. In addition, there may be a plurality of first filter capacitors arranged in parallel, and the number of the first filter capacitors can be selected according to actual needs, and is not specifically limited here.

In some embodiments, as shown in FIG. 1C, the energy storage circuit 111 further includes a boost circuit 1112 and a buck circuit 1113.

The boost circuit 1112 (Boost) is connected between the power supply 120 and the energy storage capacitor 1111, and is configured to increase the voltage of the power supply 120 to a first voltage, and store the electrical energy of the first voltage into the energy storage capacitor 1111.

The buck circuit 1113 (Buck) is connected between the energy storage capacitor 1111 and the image acquisition module 112, and is configured to buck the electric energy of the first voltage stored in the energy storage capacitor 1111 to a second voltage, and provide the electric energy of the second voltage to the image acquisition module 112.

In an implementation, the electric energy in the power supply 120 is stored, through the boost circuit 1112, into the energy storage capacitor 1111 by using a small and steady current. When the image acquisition module 112 needs a higher peak current later, the first voltage in the energy storage capacitor 1111 can be reduced, through the buck circuit 1113, to the second voltage required by the image acquisition module 112, and then the peak current is provided to the image acquisition module 112 through the energy storage capacitor 1111. In this way, the scenario where the power supply 120 directly provides the peak current to the image acquisition module 112 can be changed to the scenario where the power supply 120 stores the electric energy in the energy storage capacitor 1111 by using a small and steady current through the boost circuit 1112, and then the peak current is provided to the image acquisition module 112 by using the energy storage capacitor 1111. The power supply 120 does not need to provide a high peak current to the image acquisition module 112, but only needs to supply power through a small current, thereby avoiding the situation where the voltage of the power supply 120 drops, and thereby causing the overcurrent protection and shutdown.

Since the energy storage capacitor 1111 needs to store a certain amount of electric energy, a larger capacitor is required. In order to store this amount of electric energy, a capacitor which can afford a higher voltage value is required (for example, the energy storage capacitor CAP2 and the energy storage capacitor CAP3 in FIG. 1D both are capacitors of 330 uF/16 v). Therefore, in order to meet the voltage energy storage requirement of the energy storage capacitor 1111, the voltage of the power supply 120 needs to be increased to the first voltage (for example, from 2.7-5V to 10-20V), and the electric energy of the first voltage is stored in the energy storage capacitor 1111.

Then, in order to meet the voltage requirement of the image acquisition module 112, the first voltage of the electric energy in the energy storage capacitor 1111 needs to be reduced to the second voltage (for example, 10-20V is reduced to 4-6V) to provide the image acquisition module 112 with the electric energy of the second voltage.

Through the above scheme, the energy storage effect of the energy storage capacitor 1111 can be guaranteed, and at the same time, the image acquisition module 112 can be provided with electric energy corresponding to the required voltage, thereby ensuring the normal image acquisition operation of the image acquisition module 112.

In some embodiments, as shown in FIG. 1D, the boost circuit 1112 includes a boost inductor 11121 and a boost control chip 11122.

The boost inductor 11121 (such as L2 in FIG. 1D) is connected between the power supply 120 and the energy storage capacitor 1111, and is configured to increase the voltage of the power supply 120.

The boost control chip 11122 (such as U5 in FIG. 1D) is arranged in parallel with the boost inductor 11121, and is configured to set the first voltage and controls the boost inductor 11121 to increase the voltage of the power supply 120 to the first voltage before charging the energy storage capacitor 1111. The voltage of the energy storage capacitor 1111 after charging is the first voltage.

In an implementation, the boost control chip 11122 can be used to set the first voltage boosted by the boost inductor 11121, and control the boost process of the boost inductor 11121, such as controlling the on or off of the boost inductor 11121, and thereby controlling the timing of charging and storing energy for the energy storage capacitor 1111. Specifically, an input end of the boost inductor 11121 is connected to a first enable control interface of the boost control chip 11122 (such as the EN interface of U5 in FIG. 1D), so that when the energy storage capacitor 1111 is discharged and needs to be charged and stored with electric energy, the boost control chip 11122 turns on the boost inductor 11121 through the first enable control interface, starts to boost the voltage of the power supply 120, and stores the electric energy of the first voltage after boosting into the energy storage capacitor 1111. When the energy storage capacitor 1111 is fully charged, the boost control chip 11122 is used to control the boost inductor 11121 to be turned off through the first enable control interface, so that the boost inductor 11121 stops boosting, thereby stopping charging the energy storage capacitor 1111.

Through the above scheme, the boost process of the boost inductor 11121 can be better controlled through the boost control chip 11122, which can be used in a simple and convenient way.

In some embodiments, the boost circuit 1112 further includes a rectifier diode 11123.

The rectifier diode 11123 (such as D1 in FIG. 1D) is connected between the boost inductor 11121 and the energy storage capacitor 1111, and is configured to rectify the boosted current.

In an implementation, since the rectifier diode 11123 has a characteristic of unidirectional conduction, some reverse interference currents can be blocked by the rectifier diode 11123, thus achieving the effect of rectifying the boosted current. This prevents the reverse interference current from interfering with the energy storage effect of the energy storage capacitor 1111, and improves the energy storage effect of the energy storage capacitor 1111.

In some embodiments, the boost circuit 1112 further includes a boost feedback circuit 11124.

An output terminal of the rectifier diode 11123 is connected to a first voltage feedback interface of the boost control chip 11122 through the boost feedback circuit 11124.

The boost feedback circuit 11124 is configured to feed back the voltage rectified by the rectifier diode 11123 to the boost control chip 11122, to cause the boost control chip 11122 to compare the fed back rectified voltage with the first voltage as set, and controls the operation of the boost inductor 11121 based on the comparison results.

In an implementation, in order to further ensure the boost effect of the boost inductor 11121, it is necessary to set a boost feedback circuit 11124, which includes two boost feedback resistors (such as R26 and R30 in FIG. 1D). A first end of the resistor R26 is connected to the output terminal of the rectifier diode 11123, and a second end of the resistor R26 is connected to a first end of the resistor R30. A second end of the resistor R30 is grounded. The second end of the resistor R26 and the first end of the resistor R30 are connected to the first voltage feedback interface of the boost control chip 11122 (such as the FB interface of U5 in FIG. 1D) through a wire. Due to the voltage dividing effect of the two boost feedback resistors, the boosted output voltage (i.e., the first voltage) can be set by adjusting the resistance values of the two boost feedback resistors. In addition, the first voltage feedback interface can also receive the rectified voltage and control the operation of the boost inductor 11121 according to the rectified voltage.

Through the above scheme, the boost feedback circuit 11124 can better control the operation of the boost inductor 11121.

In some embodiments, the buck circuit 1113 includes a buck control chip 11131 and a buck inductor 11132.

The buck control chip 11131 (such as U6 in FIG. 1E) is connected to the energy storage capacitor 1111 and is configured to set the second voltage.

The buck inductor 11132 (such as L3 in FIG. 1E) is connected between the buck control chip 11131 and the image acquisition module 112, and is configured to reduce the first voltage of the energy storage capacitor 1111 to the second voltage under the control of the buck control chip 11131, thereby providing the image acquisition module 112 with electric energy of the second voltage.

In an implementation, since the electric energy in the energy storage capacitor 1111 is stored at the first voltage, but the image acquisition module 112 needs to use the electrical energy of the second voltage for powering, the buck circuit 1113 is set in order to ensure the powering effect of the image acquisition module 112. The regulation of the buck process of the buck circuit 1113 needs to be controlled by the buck control chip 11131.

In an implementation, the energy storage capacitor 1111 is connected to a power supply interface (such as the PVIN1 interface, PVIN2 interface and VIN interface of U6 in FIG. 1E) of the buck control chip 11131. The buck control chip 11131 is provided with a switch control interface (such as the SW1 or SW2 interface of U6 in FIG. 1E). The buck inductor 11132 is connected to the switch control interface, so that the buck control chip 11131 can be used to control the buck operation process of the buck inductor 11132. Then, after the buck inductor 11132 reduces the electric energy of the first voltage to the electric energy of the second voltage, the image acquisition module 112 is provided with the high current (for example, a current of 3 A) required for image acquisition, thereby ensuring the normal power demand of the image acquisition module 112 without affecting the voltage of the power supply 120.

In some embodiments, the buck circuit 1113 further includes a buck feedback circuit 11133.

An output end of the buck inductor 11132 is connected to a second voltage feedback interface of the buck control chip 11131 via the buck feedback circuit 11133.

The buck feedback circuit 11133 is configured to feed back the voltage decreased by the buck inductor 11132 to the buck control chip 11131, to cause the boost control chip 11131 to compare the fed back bucked voltage with the second voltage as set, and controls the buck inductor 11132 to adjust the voltage based on the comparison result.

In an implementation, in order to further ensure the buck effect of the buck inductor 11132, it is necessary to set a buck feedback circuit 11133, which includes two buck feedback resistors (such as R33 and R35 in FIG. 1E). A first end of the resistor R33 is connected to an output end of the buck inductor 11132, a second end of the resistor R33 is connected to a first end of the resistor R35. And a second end of the resistor R35 is grounded. The second end of the resistor R33 and the first end of the resistor R35 are connected to the second voltage feedback interface of the buck control chip 11131 (such as the FB interface of U6 in FIG. 1E) through a wire. Due to the voltage dividing effect of the two buck feedback resistors, the bucked output voltage (i.e., the second voltage) can be set by adjusting the resistance values of the two buck feedback resistors. In addition, the second voltage feedback interface can also receive the rectified voltage and control the operation of the buck inductor 11132 according to the rectified voltage.

Through the above scheme, the buck feedback circuit 11133 can better control the operation of the buck inductor 11132.

In some embodiments, the buck circuit 1113 also includes a second filter capacitor.

One end of the second filter capacitor (such as C37, C34, C35 in FIG. 1E) is connected to the buck circuit 1113 and the image acquisition module 112 and the other end of the second filter capacitor is grounded.

In an implementation, in order to avoid the interference from alternating current (AC) pulsating currents, due to the characteristics of passing through AC and blocking DC for the filter capacitor, a second filter capacitor is set. One end of the second filter capacitor is connected to the buck circuit 1113 and the image acquisition module 112, and the other end of the second filter capacitor is grounded. It is possible to filter out some of AC electricity in the electric energy bucked through the buck circuit 1113, so that the electric energy provided to the image acquisition module 112 is relatively stable and will not be affected by the AC electricity. In addition, there may be a plurality of second filter capacitor arranged in parallel, and the number of the second filter capacitor can be selected according to actual needs, and is not specifically limited here.

In some embodiments, in order to further ensure the stability of the boost circuit 1112 and the buck circuit 1113, the input end of the boost circuit 1112 and/or the input end of the buck circuit 1113 is connected to a third filter capacitor (for example, C40 in FIG. 1D, C39 in FIG. 1E) to filter out some of the input AC pulsating currents, which can prevent these AC pulsating currents from affecting the normal operation of the boost circuit 1112 and/or the buck circuit 1113.

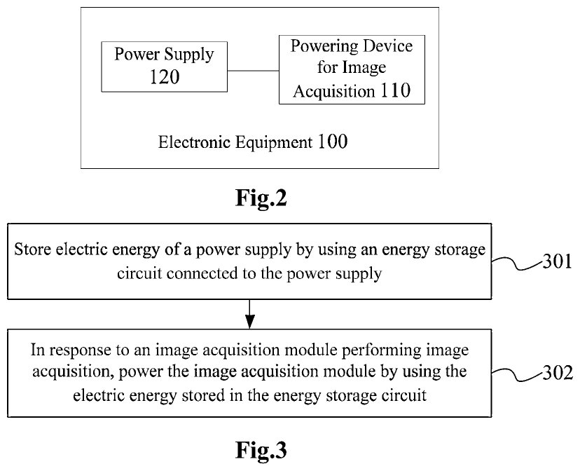

Based on the same concept, the electronic equipment 100 proposed in the embodiment of the present application, as shown in FIG. 2, includes: a power supply 120 and the powering device for image acquisition 110 according to the above embodiments, which is connected to the power supply 120.

The electronic equipment 100 according to the above embodiment has the same technical effects as the powering device for image acquisition 110 according to each of the above embodiments, which will not be described again here.

The electronic equipment 100 can be at least one of a mobile phone, a computer, a tablet, a wearable device, and an extended reality device. Preferably, it is an Extended Reality (XR) device. XR refers to combining the real and the virtual through a computer to create a virtual environment for human-computer interaction. This is also a general term for various technologies such as Augmented Reality (AR), Virtual Reality (VR), and Mixed Reality (MR). It can allow users to interact with the virtual digital world, thereby providing users with a richer experience. For example, it is used for learning purposes, gaming purposes, content creation purposes, social media and interactive purposes, etc.

Extended reality device is a computer simulation device that can create and experience the virtual world. It uses computer programs to generate a simulated environment, providing a multi-source information fusion, interactive three-dimensional dynamic vision and entity behavior simulation, allowing users to immerse themselves in the virtual environment.

The extended reality device includes a main controller, Digital Signal Processing (DSP), memory, storage, position sensor, camera, radio frequency wireless transmission circuit, antenna and other units. The spatial position information is collected through the camera. The position of the handle is obtained through sensors and labels on the handle that indicate the relative position to the Helmet Mounted Display (HMD). The radio frequency wireless transmission circuit obtains the angular velocity and gravity acceleration data of the handle. The HMD processes the relevant data. The HMD calculates the 3D position and 3D angle information of the handle and HMD in space based on the obtained data, and updates the image to display the handle model on the screen according to the calculated position and angle.

Based on the same concept, the embodiment proposes a powering method for image acquisition, which is applied to the powering device for image acquisition of the above embodiment.

As shown in FIG. 3, the method includes:

Step 301: storing electric energy of a power supply by using an energy storage circuit connected to the power supply;

Step 302: powering, in response to an image acquisition module performing image acquisition, the image acquisition module by using the electric energy stored in the energy storage circuit.

In some embodiments, the energy storage circuit includes: a boost circuit, an energy storage capacitor, and a buck circuit connected in sequence between the power supply and the image acquisition module.

Step 301 includes: boosting the voltage of the power supply by using the boost circuit, and after the voltage is boosted to a first voltage, storing the electric energy of the power supply in the energy storage capacitor at the first voltage.

Step 302 includes: in response to the image acquisition module performing image acquisition, bucking the electric energy of the first voltage stored in the energy storage capacitor to a second voltage by using the buck circuit, to power the image acquisition module with electric energy of the second voltage.

It should be noted that the method of the embodiment of the present application can be performed by a single device, such as a computer or server. The method of the embodiment can also be applied to a distributed scenario and completed by multiple devices cooperating with each other. In the case of such a distributed scenario, one of the multiple devices can only perform one or more steps in the method of the embodiment of the present application, and the multiple devices will interact with each other to complete the described method.

It should be noted that some embodiments of the present application have been described above. Other embodiments are within the scope of the appended claims. In some cases, the actions or steps recited in the claims can be performed in a different order than in the above-described embodiments and still achieve the desired results. Additionally, the processes depicted in the figures do not necessarily require the specific order shown, or sequential order, to achieve desirable results. Multitasking and parallel processing are also possible or may be advantageous in certain implementations.

Based on the same concept, corresponding to the method according to any of the above embodiments, the present application also provides a non-transitory computer-readable storage medium. The non-transitory computer-readable storage medium stores computer instructions, and the computer instructions are used for causing the computer to execute the method according to any of the above embodiments.

The computer-readable medium in the embodiment includes permanent and non-permanent, removable and non-removable media, and information storage can be implemented by any method or technology. Information may be computer-readable instructions, data structures, modules of programs, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disc read-only memory (CD-ROM), digital versatile disc (DVD) or other optical storage, magnetic tape cassettes, magnetic tape, disk storage or other magnetic storage devices, or any other non-transmission medium that can be used to store information that can be accessed by a computing device.

The computer instructions stored in the storage medium of the above embodiments are used to enable the computer to execute the method as according to any of the above embodiments, and have the beneficial effects of the corresponding method embodiments, which will not be repeated here.

Based on the same concept, corresponding to the method according to any of the above embodiments, the present application also provides a computer program product, including computer program instructions. When the computer program instructions are run on a computer, the computer executes the method according to any of the above embodiments, which has the beneficial effects of the corresponding method embodiments and will not be repeated here.

Those of ordinary skilled in the art should understand that the discussion of any above embodiments is only illustrative, and is not intended to imply that the scope of the present application (including the claims) is limited to these examples. Under the spirit of the present application, the above embodiments or technical features in different embodiments can also be combined, steps can be implemented in any order. There are many other variations of different aspects of the embodiments of the present application as described above, which are not provided in detail for the sake of simplicity.

In addition, to simplify the description and discussion, and in order not to make the embodiments of the present application difficult to understand, the known power/ground connections to the integrated circuit (IC) chip and other components may or may not be shown in the provided drawings. In addition, the device may be shown in the form of a block diagram to avoid making the embodiments of the present application difficult to understand. This also considers the fact that the details of the implementation of these block diagram devices are highly dependent on the platform on which the embodiments of the present application are to be implemented (that is, these details should be fully within the scope of understanding of those skilled in the art). Where specific details (e.g., circuits) are set forth to describe exemplary embodiments of the present application, it is obvious to those skilled in the art that the embodiments of the present application can be implemented without these specific details or with changes in these specific details. Therefore, these descriptions should be considered illustrative rather than restrictive.

Although the present application has been described in conjunction with specific embodiments thereof, many alternatives, modifications and variations of these embodiments will be apparent to those of ordinary skilled in the art from the foregoing description. For example, other memory architectures (e.g., dynamic RAM (DRAM)) may use the discussed embodiments.

The present embodiments are intended to embrace all such alternatives, modifications and variations that fall within the broad scope of the appended claims. Therefore, any omissions, modifications, equivalent substitutions, improvements, etc. made within the spirit and principles of the embodiments of the present application shall be included in the protection scope of the present application.

I/We claim:

1. A powering device for image acquisition, comprising:
an energy storage circuit connected to a power supply and configured to store electric energy of the power supply; and
an image acquisition module connected to the energy storage circuit and configured to use the electric energy stored in the energy storage circuit for powering during image acquisition.

2. The powering device according to claim 1, wherein the energy storage circuit comprises:
an energy storage capacitor configured to store the electric energy of the power supply in the energy storage capacitor.

3. The powering device according to claim 2, wherein the energy storage circuit further comprises:
a boost circuit connected between the power supply and the energy storage capacitor, and configured to increase a voltage of the power supply to a first voltage and store the electric energy of the first voltage in the energy storage capacitor; and
a buck circuit connected between the energy storage capacitor and the image acquisition module, and configured to reduce the electric energy of the first voltage stored in the energy storage capacitor to a second voltage, and provide the electric energy of the second voltage to the image acquisition module.

4. The powering device according to claim 3, wherein the boost circuit comprises:
a boost inductor connected between the power supply and the energy storage capacitor, and configured to increase a voltage of the power supply; and
a boost control chip arranged in parallel with the boost inductor, and configured to set the first voltage and control the boost inductor to increase the voltage of the power supply to the first voltage before charging the energy storage capacitor, wherein a voltage of the energy storage capacitor after charging is the first voltage.

5. The powering device according to claim 4, wherein the boost circuit further comprises:
a rectifier diode connected between the boost inductor and the energy storage capacitor, and configured to rectify the boosted current.

6. The powering device according to claim 5, wherein the boost circuit further comprises:
a boost feedback circuit, wherein an output terminal of the rectifier diode is connected to a first voltage feedback interface of the boost control chip through the boost feedback circuit;
wherein the boost feedback circuit is configured to feed back the voltage rectified by the rectifier diode to the boost control chip, to cause the boost control chip to control an operation of the boost inductor based on the fed back rectified voltage.

7. The powering device according to claim 3, wherein the buck circuit comprises:
a buck control chip connected to the energy storage capacitor, and configured to set the second voltage; and
a buck inductor connected between the buck control chip and the image acquisition module, and configured to reduce the first voltage of the energy storage capacitor to the second voltage according to the control of the buck control chip, and provide the electric energy of the second voltage to the image acquisition module.

8. The powering device according to claim 7, wherein the buck circuit further comprises:
a buck feedback circuit, wherein an output end of the buck inductor is connected to a second voltage feedback interface of the buck control chip through the buck feedback circuit;
wherein the buck feedback circuit is configured to feed back the voltage bucked by the buck inductor to the buck control chip, to cause the buck control chip to control an operation of the buck inductor based on the fed back bucked voltage.

9. An electronic equipment comprising a power supply and the powering device for image acquisition connected to the power supply, wherein the powering device for image acquisition comprises:
an energy storage circuit connected to the power supply and configured to store electric energy of the power supply; and
an image acquisition module connected to the energy storage circuit and configured to use the electric energy stored in the energy storage circuit for powering during image acquisition.

10. The electronic equipment according to claim 9, wherein the energy storage circuit comprises:
an energy storage capacitor configured to store the electric energy of the power supply in the energy storage capacitor.

11. The electronic equipment according to claim 10, wherein the energy storage circuit further comprises:
a boost circuit connected between the power supply and the energy storage capacitor, and configured to increase a voltage of the power supply to a first voltage and store the electric energy of the first voltage in the energy storage capacitor; and
a buck circuit connected between the energy storage capacitor and the image acquisition module, and configured to reduce the electric energy of the first voltage stored in the energy storage capacitor to a second voltage, and provide the electric energy of the second voltage to the image acquisition module.

12. The electronic equipment according to claim 11, wherein the boost circuit comprises:
a boost inductor connected between the power supply and the energy storage capacitor, and configured to increase a voltage of the power supply; and
a boost control chip arranged in parallel with the boost inductor, and configured to set the first voltage and control the boost inductor to increase the voltage of the power supply to the first voltage before charging the energy storage capacitor, wherein a voltage of the energy storage capacitor after charging is the first voltage.

13. The electronic equipment according to claim 12, wherein the boost circuit further comprises:
a rectifier diode connected between the boost inductor and the energy storage capacitor, and configured to rectify the boosted current.

14. The electronic equipment according to claim 13, wherein the boost circuit further comprises:
a boost feedback circuit, wherein an output terminal of the rectifier diode is connected to a first voltage feedback interface of the boost control chip through the boost feedback circuit;
wherein the boost feedback circuit is configured to feed back the voltage rectified by the rectifier diode to the boost control chip, to cause the boost control chip to control an operation of the boost inductor based on the fed back rectified voltage.

15. The electronic equipment according to claim 11, wherein the buck circuit comprises:
a buck control chip connected to the energy storage capacitor, and configured to set the second voltage; and
a buck inductor connected between the buck control chip and the image acquisition module, and configured to reduce the first voltage of the energy storage capacitor to the second voltage according to the control of the buck control chip, and provide the electric energy of the second voltage to the image acquisition module.

16. The electronic equipment according to claim 15, wherein the buck circuit further comprises:
a buck feedback circuit, wherein an output end of the buck inductor is connected to a second voltage feedback interface of the buck control chip through the buck feedback circuit;
wherein the buck feedback circuit is configured to feed back the voltage bucked by the buck inductor to the buck control chip, to cause the buck control chip to control an operation of the buck inductor based on the fed back bucked voltage.

17. A powering method for image acquisition, comprising:
storing electric energy of a power supply by using an energy storage circuit connected to the power supply;
powering, in response to an image acquisition module performing image acquisition, the image acquisition module by using the electric energy stored in the energy storage circuit.

18. The powering method according to claim 17, wherein the energy storage circuit comprises:
a boost circuit, an energy storage capacitor, and a buck circuit sequentially connected between the power supply and the image acquisition module.

19. The powering method according to claim 18, wherein the storing the electric energy of the power supply by using the energy storage circuit connected to the power supply comprises:
boosting a voltage of the power supply by using the boost circuit, and after the voltage is boosted to a first voltage, storing the electric energy of the power supply at the first voltage in the energy storage capacitor.

20. The powering method according to claim 18, wherein the powering, in response to the image acquisition module performing image acquisition, the image acquisition module by using the electric energy stored in the energy storage circuit comprises:
bucking, in response to the image acquisition module performing image acquisition, electric energy of the first voltage stored in the energy storage capacitor to a second voltage by using the buck circuit, to power the image acquisition module with electric energy of the second voltage.
